(19) United States
(12) Patent Application Publication
(10) Pub. No.: US 2020/0213745 A1
(43) Pub. Date: Jul. 2, 2020

(54) SPEAKER

(71) Applicant: AAC Technologies Pte. Ltd., Singapore city (SG)

(72) Inventor: Chengming Cao, Shenzhen (CN)

(21) Appl. No.: 16/705,200

(22) Filed: Dec. 5, 2019

(30) Foreign Application Priority Data
Dec. 29, 2018 (CN) 201822268446.9

(51) Int. Cl. H04R 9/02; H04R 9/06

(52) U.S. Cl. CPC H04R 9/025; H04R 2209/041; H04R 9/06

(57) ABSTRACT

A speaker includes a vibration structure, a magnetic circuit structure, and a housing having a cavity receiving the vibration structure and the magnetic circuit, the vibration structure comprises: a diaphragm fixed to the housing and a voice coil driving the diaphragm to vibrate and sound, the diaphragm comprises a dome located at an intermediate position and a suspension connected to the dome, the suspension comprises a first fixing portion fixed to the housing, a second fixing portion connected to the dome, and a wrinkle portion that connects the first fixing portion with the second fixing portion, the dome is fixed at a side of the second fixing portion facing towards the voice coil, and comprises an edge portion connected to the voice coil, and the edge portion comprises a recessed portion formed by recessing from a surface connected to the voice coil along a direction away from the voice coil.

### TECHNICAL FIELD

The present disclosure relates to the field of sounder technologies, and in particular, to a speaker.

### BACKGROUND

A speaker is an acoustic component commonly used in an electronic device, and is an electric-acoustic converter. The existing speaker generally includes a housing having a cavity, a vibration structure and a magnetic circuit structure. The vibration structure and the magnetic circuit structure are arranged in the cavity of the housing, and divides the cavity into a front cavity and a rear cavity. The vibration structure includes a voice coil and a diaphragm. The diaphragm includes a dome and a suspension. The dome and the voice coil are generally bonded by gluing. Because the amount of glue is not easily controlled, it is prone to have a problem of excessive glue affecting the pure tone yield.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic view of a speaker according to the present disclosure;

FIG. 2 is an exploded structural schematic view of the speaker shown in FIG. 1;

FIG. 3 is a structural top view of the speaker shown in FIG. 1;

FIG. 4 is a cross-sectional structural schematic view taken in a direction A-A shown in FIG. 3;

FIG. 5 is an enlarged structural schematic view of a region B shown in FIG. 4;

FIG. 6 is a structural schematic view of a suspension shown in FIG. 2; and

FIG. 7 is a structural schematic view of a yoke shown in FIG. 2;

In the drawings, the reference signs represent: 1, housing; 11, holder; 12, upper cover; 2, vibration structure; 21, diaphragm; 211, dome; 2111, recessed portion; 212, suspension; 2121, first fixing portion; 2122, second fixing portion; 2123, wrinkle portion; 22, voice coil; 3, magnetic circuit structure; 31, yoke; 311, substrate; 312, magnetic conductive side plate; 32, magnet; 33, washer.

### DESCRIPTION OF EMBODIMENTS

The present disclosure will be further illustrated with reference to the accompanying drawings and the embodiments.

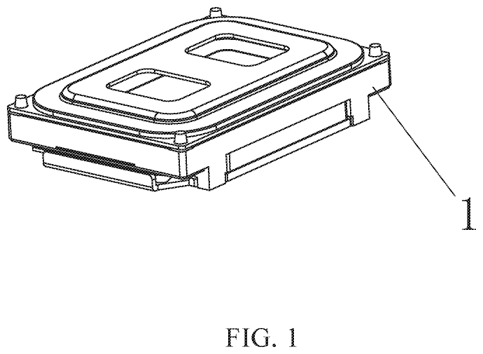

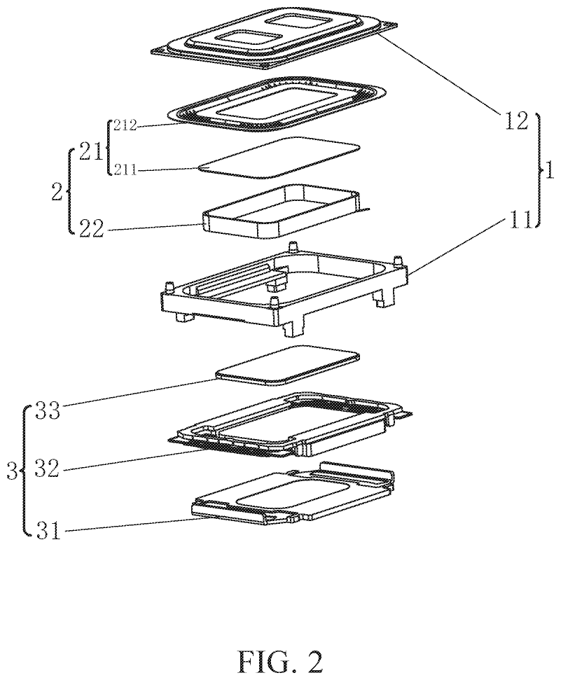

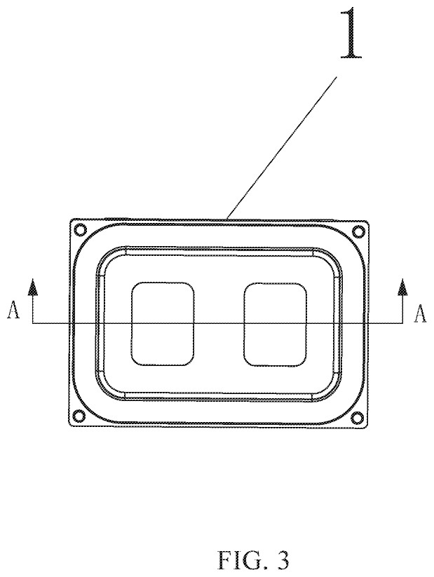

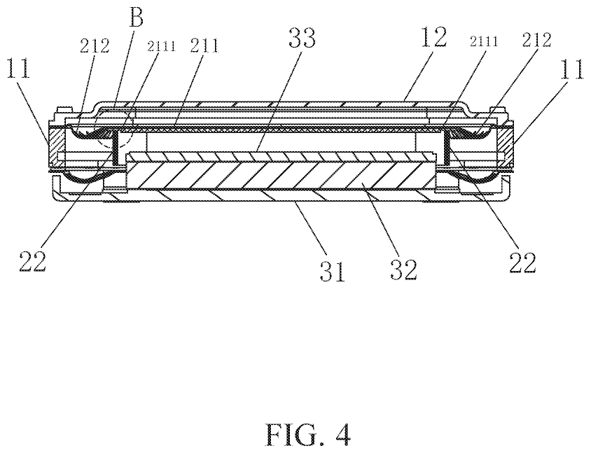

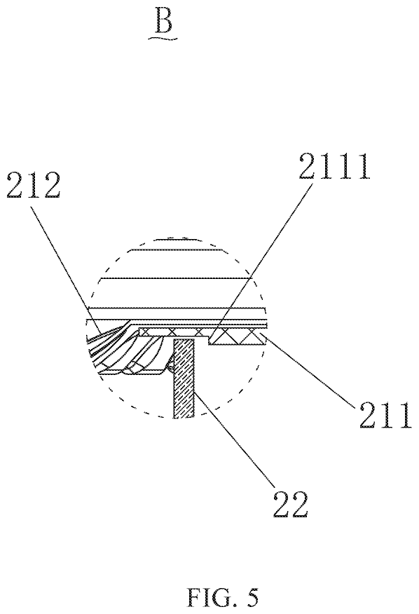

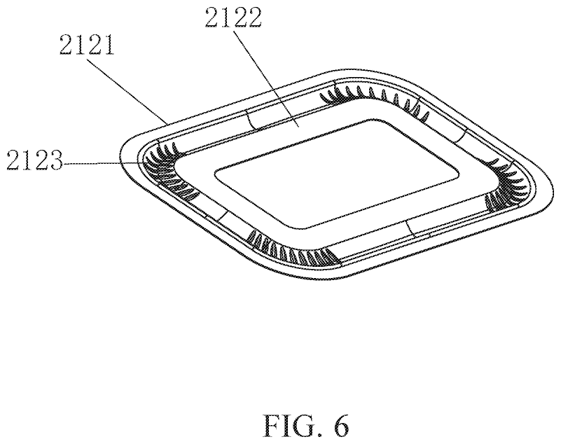

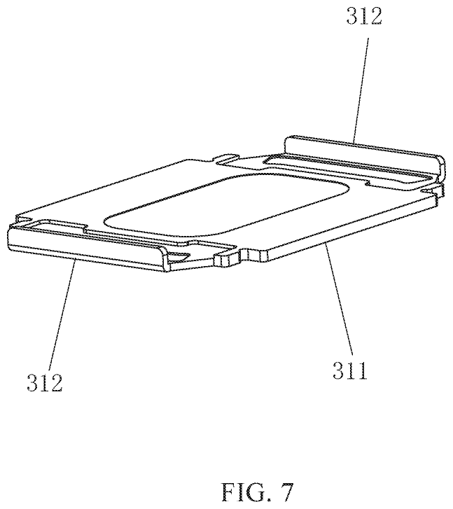

As shown in FIGS. 1-7, an embodiment of the present disclosure provides a speaker. The speaker includes: a housing 1 having a receiving cavity, a vibration structure 2, and a magnetic circuit structure 3. The vibration structure 2 and the magnetic circuit structure 3 are assembled in the receiving cavity. The vibration structure 2 includes: a diaphragm 21 fixed to the housing 1, and a voice coil 22 which drives the diaphragm 21 to vibrate and sound. The diaphragm 21 includes a dome 211 located at an intermediate position, and a suspension 212 connected to the dome. The suspension 212 includes a first fixing portion 2121 fixed to the housing 1, a second fixing portion 2122 connected to the dome 211, and a wrinkle portion 2123 that connects the first fixing portion 2121 with the second fixing portion 2122. The dome 211 is fixed at a side of the second fixing portion 2122 facing towards the voice coil 22, and includes an edge portion connected to the voice coil 22. The edge portion includes a recessed portion 2111 formed by recessing from a surface connected to the voice coil 22 along a direction away from the voice coil 22.

In the speaker according to this embodiment, the edge portion of the dome 211 connected to the voice coil 22 includes a recessed portion 2111, so that a gap is provided as a glue storage space between the dome 211 and an inner wall of the voice coil 22. After a glue is glued between the dome 211 and the voice coil 22, the glue is stored in the gap, and will not overflow to a lower surface of the dome 211 and the inner wall of the voice coil 22, thereby improving the pure tone yield of the speaker.

As shown in FIGS. 1-7, in an embodiment, the housing 1 includes: a holder 11 and an upper cover 12. The holder 11 has a rectangular frame shape, and is provided with an open cavity. The upper cover 12 covers the top of the open cavity. The magnetic circuit structure 3 includes a yoke 31, a magnet 32, and a washer 33. The yoke 31 includes a substrate 311 and a magnetic conductive side plate 312. The substrate 311 is a rectangular plate. The magnetic conductive side plate 312 is arranged at a peripheral side of the substrate 311 and protrudes from a plate surface of the substrate 311. When the yoke 31 is assembled on the holder 11, the magnetic side plate 312 goes deep into the through cavity, and a gap is formed between the magnetic conductive side plate 312 and the inner wall of the holder 11. The magnet 32 is assembled on the substrate 311 of the yoke 31. The magnetic conductive side plate 312 of the yoke 31 surrounds the magnet 32, and a gap is formed between the magnetic conductive side plate 312 and the magnet 32. The washer 33 is assembled at a side of the magnet 32 facing away from the substrate 311.

The above are only embodiments of the present disclosure. Here, it should be noted that those skilled in the art can make modifications without departing from the inventive concept of the present disclosure, but these shall fall into the protection scope of the present disclosure.

What is claimed is:

1. A speaker, comprising:
a housing having a receiving cavity;
a vibration structure comprises a diaphragm fixed to the housing and a voice coil configured to drive the diaphragm to vibrate and sound; and
a magnetic circuit structure,
wherein the vibration structure and the magnetic circuit structure are assembled in the receiving cavity, the diaphragm comprises a dome located at an intermediate position and a suspension connected to the dome, and the suspension comprises a first fixing portion fixed to the housing, a second fixing portion connected to the dome, and a wrinkle portion that connects the first fixing portion with the second fixing portion,
wherein the dome is fixed at a side of the second fixing portion facing towards the voice coil, and comprises an edge portion connected to the voice coil, and the edge portion comprises a recessed portion formed by recessing from a surface connected to the voice coil along a direction facing away from the voice coil.

2. The speaker as described in claim 1, wherein the housing comprises a holder and an upper cover, the holder being provided with an open cavity and the upper cover covering a top of the open cavity.

3. The speaker as described in claim 2, wherein the magnetic circuit structure comprises a yoke, the yoke comprises a substrate and a magnetic side plate, the magnetic side plate is arranged at a peripheral side of the substrate and protrudes from a plate surface of the substrate, and the magnetic side plate goes deep into the open cavity when the yoke is assembled on the holder.

4. The speaker as described in claim 3, wherein the magnetic circuit structure further comprises a magnet and a washer, the magnet being assembled on the substrate of the yoke, and the washer being assembled at a side of the magnet facing away from the substrate.
